(19) United States
(12) Patent Application Publication
(10) Pub. No.: US 2004/0134854 A1
(43) Pub. Date: Jul. 15, 2004

(54) Small liquid particle handling method, and device therefor

(76) Inventors: Toshiro Higuchi, Kanagawa (JP); Toru Torii, Tokyo (JP); Tomohiro Taniguchi, Chiba (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/468,020

(22) PCT Filed: Feb. 21, 2002
(86) PCT No.: PCT/JP02/01529

(30) Foreign Application Priority Data
Feb. 23, 2001 (JP) 2001-48096
Aug. 7, 2001 (JP) 2001-238625

(51) Int. Cl. B01D 11/00

(52) U.S. Cl. 210/634; 210/511; 366/340; 422/129; 264/600

(57) ABSTRACT

A liquid particulate-handling method and device, in which the evaporation of the droplets is prevented and therefore the handing of the droplets is appropriately performed, are provided.

In the handling of liquid particulates, a chemically inert solution (4), having microdroplets (5) therein, is set on a substrate (1) having handling electrodes (2) arranged in a two-dimensional manner; and the voltages of the handling electrodes (2) are controlled, thereby handling the microdroplets (5).

### TECHNICAL FIELD

The present invention relates to techniques for handling liquid particulates, such as microdroplets and microcapsules, suspended in water, oil, or chemically inert liquid. The present invention particularly relates to a method and device for handling such liquid particulates in order to transport, combine, agitate, or separate fine particles suspended in liquid.

### BACKGROUND ART

Currently, in the field of a micro-total analysis system (μ-TAS) and combinatorial chemistry, the following operations have been demanded: reaction, analysis, and identification in which a trace quantity of samples are used.

In conventional techniques in this field, the following system has been proposed (see, for example, Japanese Unexamined Patent Application Publication No. 10-267801): a microchemical reaction and analysis system in which droplets containing a sample or a reagent are manipulated on a hydrophobic surface and liquid particulates arranged on an array of electrodes are handled by applying voltages to the electrodes in turn, whereby the system includes no valves and pumps.

### DISCLOSURE OF INVENTION

However, in the above conventional handling method, since the droplets are placed on the hydrophobic surface, there is a problem in that the micro-sized droplets evaporate.

In view of the above situation, it is an object of the present invention to provide a liquid particulate-handling method and device in which the evaporation of the droplets is prevented and therefore the handing of the droplets is appropriately performed.

In order to achieve the above object, the following methods and devices are provided.

(1) A method for handling liquid particulates includes steps of setting a chemically inert solution, having microdroplets therein, on a substrate having handling electrodes arranged in a two-dimensional manner; controlling the voltages of the handling electrodes; and handling the microdroplets.

(2) The liquid particulate-handling method described in the above article (1) further includes a step of combining the microdroplets to cause chemical reaction.

(3) A device for handling liquid particulates includes a substrate having handling electrodes arranged in a two-dimensional manner, a chemically inert solution set for the substrate, microdroplets placed in the solution, and a controller for controlling the voltages of the handling electrodes.

(4) A device for handling liquid particulates includes a substrate having handling electrodes arranged in a two-dimensional manner, a chemically inert solution set for the substrate, microdroplets placed in the solution, and a controller for controlling the voltages of the handling electrodes, wherein a plurality of the microdroplets are controlled, whereby combining is performed.

(5) A method for handling liquid particulates includes steps of setting a chemically inert solution, having a plurality of microdroplets therein, on a substrate having handling electrodes arranged in a two-dimensional manner; controlling the voltages of the handling electrodes; and handling a plurality of the microdroplets to combine a plurality of the microdroplets each other.

(6) The liquid particulate-handling method described in the above article (5), wherein the combining is performed by a multi-step process.

(7) A method for handling liquid particulates includes steps of setting a chemically inert solution, having a plurality of microdroplets therein, on a substrate having handling electrodes arranged in a two-dimensional manner; controlling the voltages of the handling electrodes; and handling a plurality of the microdroplets to combine a plurality of the microdroplets to form microcapsules.

(8) A method for handling liquid particulates includes steps of setting a chemically inert solution, having microdroplets therein, on a substrate having handling electrodes arranged in a two-dimensional manner; controlling the voltages of the handling electrodes; and handling the microdroplets to separate the microdroplets.

(9) A method for handling liquid particulates includes steps of setting a chemically inert solution, having a plurality of microdroplets therein, on a substrate having handling electrodes arranged in a two-dimensional manner; controlling the voltages of the handling electrodes; and handling a plurality of the microdroplets to separate small microdroplets having a size smaller than or equal to a predetermined value from the microdroplets having different sizes by filtration.

(10) A method for handling liquid particulates includes steps of setting a chemically inert solution, having a plurality of microdroplets therein, on a substrate having handling electrodes arranged in a two-dimensional manner; controlling the voltages of the handling electrodes; and handling a plurality of the microdroplets, wherein the substrate has an electrostatic transport tube, disposed thereon, for transporting the microdroplets so as to provide a transport channel.

(11) A device for handling liquid particulates includes a substrate having handling electrodes arranged in a two-dimensional manner; a chemically inert solution, set for the substrate, having a plurality of microdroplets therein; a controller for controlling the voltages of the handling electrodes; and an means for handling a plurality of the microdroplets to combine a plurality of the microdroplets each other.

(12) In the liquid particulate-handling device described in the above article (4) or (11), the substrate has a guide, whereby the droplets are combined.

(13) In the liquid particulate-handling device described in the above article (4) or (11), the substrate has a guide, whereby the droplets are combined at a plurality of regions.

(14) In the liquid particulate-handling device described in the above article (4) or (11), the microdroplets are moved on the substrate such that the microdroplets are combined or mixed.

(15) The liquid particulate-handling device described in the above article (4) or (11) further includes a dividing means for dividing each microdroplet, moved on the substrate, into a plurality of sub-microdroplets.

(16) The liquid particulate-handling device described in the above article (4) or (11) further includes a filter for separating small microdroplets having a size smaller than or equal to a predetermined value from a plurality of the microdroplets having different sizes.

(17) The liquid particulate-handling device described in the above article (4) or (11), wherein the substrate has an electrostatic transport tube, disposed thereon, for transporting liquid particulates.

(18) In the liquid particulate-handling device described in the above article (3), (4), or (11), the substrate is placed below the solution.

(19) In the liquid particulate-handling device described in the above article (3), (4), or (11), the substrate is placed above the solution.

As described above, the present invention relates to methods in which an array of electrodes covered with a solution is prepared such that liquid particulates or microspheres placed in the solution are handled and also relates to devices for such methods.

The electrodes may be arranged in line in parallel to the X-axis or the Y-axis and may be arranged in a dotted pattern such that intersections function as the electrodes. Furthermore, wedge-shaped obstacles may be arranged on the X-Y plane. Voltages are applied to the electrodes in a traveling wave pattern such that the particulates can be transported in an arbitrary manner, thereby performing combining, mixing, separation, and agitation in an arbitrary manner.

### BRIEF DESCRIPTION OF THE DRAWINGS

FIG. 1 is a schematic sectional view showing a liquid particulate-handling device according to a first example of the present invention.

FIG. 2 is an illustration showing a first handling method using the liquid particulate-handling device according to the first example of the present invention.

FIG. 3 is an illustration showing a second handling method using a handling device of the present invention.

FIG. 4 is a schematic sectional view showing a liquid particulate-handling device according to a second example of the present invention.

FIG. 5 is an illustration showing a handling method using the liquid particulate-handling device according to the second example of the present invention.

FIG. 6 is a plan view showing a device for producing microdroplets according to the present invention.

FIG. 7 is an illustration showing a process for producing such microdroplets.

FIG. 8 is a plan view showing a device for producing microcapsules according to the present invention.

FIG. 9 is an illustration showing a process for producing such microcapsules.

FIG. 10 is an illustration (photographs in place of drawings) showing a technique for combining two types of microdroplets according to the present invention.

FIG. 11 is an illustration showing a technique for combining two types of microdroplets according to the present invention, wherein the microdroplets are combined at a plurality of locations.

FIG. 12 is an illustration (No. 1) showing a technique for combining a plurality of microdroplets using dot electrodes according to the present invention.

FIG. 13 is an illustration (No. 2) showing a technique for combining a plurality of microdroplets using dot electrodes according to the present invention.

FIG. 14 is an illustration showing a technique for combining a plurality of microdroplets using dot electrodes by a multi-step process according to the present invention.

FIG. 15 is an illustration (photographs in place of drawings) showing a technique for combining a plurality of microdroplets using dot electrodes by a multi-step process according to the present invention.

FIG. 16 is an illustration showing a configuration of a device, including parallel electrodes, for combining microdroplets according to the present invention.

FIG. 17 is an illustration showing a technique for mixing microdroplets according to the present invention.

FIG. 18 is an illustration showing a configuration of a device for dividing microdroplets according to an example of the present invention.

FIG. 19 is an illustration showing a configuration of a device for separating (filtrating) microdroplets according to an example of the present invention.

FIG. 20 is an illustration showing a configuration of a microdroplet-handling device including an electrostatic transport tube for transporting microdroplets according to an example of the present invention.

FIG. 21 is a schematic sectional view showing a microdroplet-handling device according to an example of the present invention, wherein the microdroplet-handling device has a substrate, disposed above a solution, having handling electrodes.

FIG. 22 is an illustration showing a method for handling liquid particulates using a handling device according to an example of the present invention, wherein the microdroplet-handling device has a substrate, disposed above solution, having handling electrodes.

FIG. 23 is an illustration showing a substrate having handling electrodes and also showing a method for applying voltages according to an example of the present invention.

### BEST MODE FOR CARRYING OUT THE INVENTION

Embodiments of the present invention will now be described in detail with reference to the accompanying drawings.

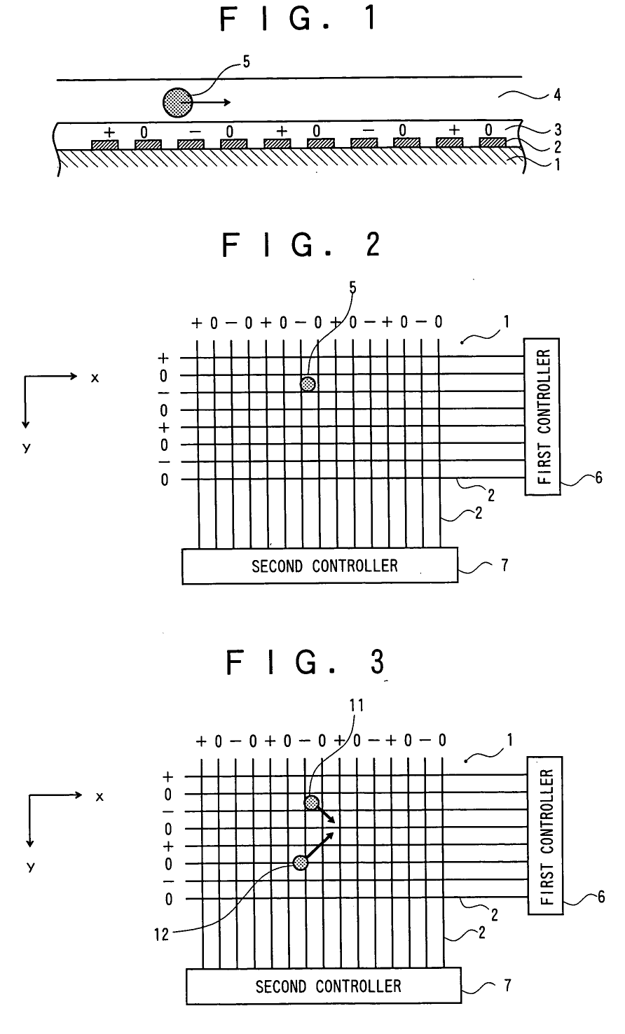

FIG. 1 is a schematic sectional view showing a liquid particulate-handling device according to a first example of the present invention. FIG. 2 is an illustration showing a first handling method using the liquid particulate-handling device.

In these figures, reference numeral 1 represents a substrate, reference numeral 2 represents electrode lines disposed on the substrate 1, reference numeral 3 represents a hydrophobic insulating layer covering the electrode lines 2, reference numeral 4 represents a chemically inert solution (for example, oil), reference numeral 5 represents a microdroplet (for example, water), reference numeral 6 represents a first controller for controlling the voltages of the electrode lines 2 arranged in the x direction, and reference numeral 7 represents a second controller for controlling the voltages of the electrode lines 2 arranged in the y direction.

As shown in FIG. 2, each microdroplet 5 is placed above the substrate 1, on which the electrode lines 2 are arranged in a two-dimensional manner, and the voltages of the electrode lines 2 are controlled with the first controller 6 and/or the second controller 7, thereby manipulating the microdroplet 5 in an arbitrary two-dimensional direction.

The principle of the migration of the microdroplet 5 is as follows: since the surface of the microdroplet 5 is positively or negatively charged, repulsion or attraction arises between the electrode lines 2 and the microdroplet 5. Furthermore, a driving force can be applied to the microdroplet 5 by applying voltages to the electrode lines 2 in a traveling wave pattern. Since electrodes are arranged in a two-dimensional manner, the microdroplet 5 can be moved in an arbitrary two-dimensional direction.

As described above, in this example, the electrode lines 2 are arranged in a grid pattern. Such electrode lines 2 can be readily manufactured using a micro-wiring technique (semiconductor technology).

In this example, the electrode lines are arranged in a grid pattern. However, the arrangement of the electrode lines is not limited to such a pattern.

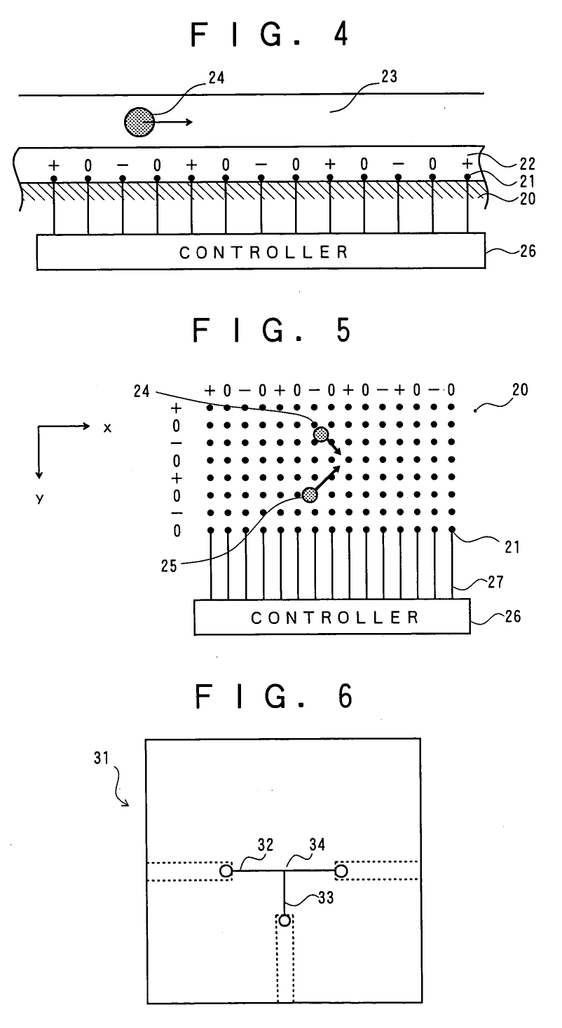

FIG. 3 is an illustration showing a second handling method using a handling device of the present invention. The handling device has the same configuration as that shown in FIG. 1.

As shown in FIG. 3, two microdroplets 11 and 12 are placed above the substrate 1, on which the electrode lines 2 are arranged in a two-dimensional manner, and the voltages of the electrode lines 2 are controlled with the first controller 6 and/or the second controller 7, thereby moving the two microdroplets 11 and 12 to join them together.

That is, when different moving electric fields are applied to two droplets, the two droplets can be caused to collide. Thereby, chemical reaction can be caused between the microdroplets.

As a matter of course, the microdroplets 11 and 12 can be agitated, and combined microdroplets can be separated by precisely controlling the voltages with the first controller 6 and/or the second controller 7.

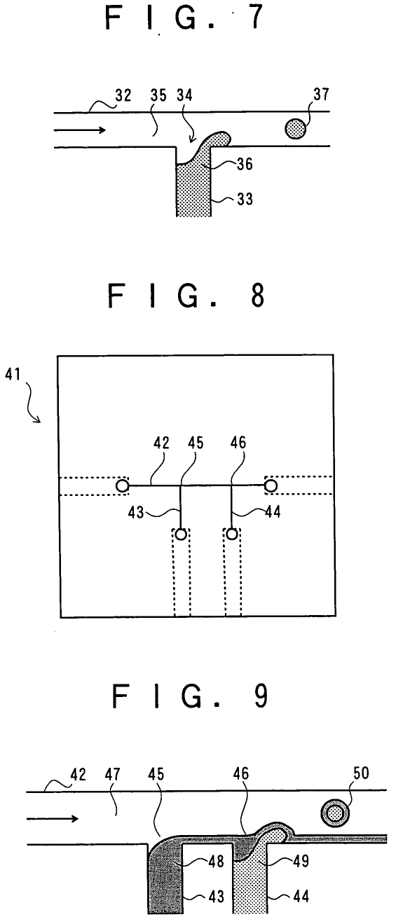

FIG. 4 is a schematic sectional view showing a liquid particulate-handling device according to a second example of the present invention. FIG. 5 is an illustration showing a handling method using the liquid particulate-handling device.

In the first example, the electrode lines are arranged in a grid pattern. In the second example, as shown in FIGS. 4 and 5, dot electrodes 21 may be arranged on a substrate 20 in a matrix. Reference numeral 23 represents a chemically inert solution (for example, oil) and reference numerals 24 and 25 represent microdroplets (for example, water). A controller 26 for controlling the voltages of the dot electrodes 21 is placed. For example, the dot electrodes 21 may be connected to corresponding wiring lines 27, disposed on the back face of the substrate 20, via through-holes (not shown). Reference numeral 22 represents an insulating layer covering the dot electrodes 21.

The microdroplets 24 and 25 can be moved and then combined into one droplet by the control with the controller 26.

According to such a configuration, desired voltages can be applied to the dot electrodes 21 in a dotted manner, thereby performing the appropriate handling of droplets at high resolution.

The production of microdroplets (including microcapsules) will now be described.

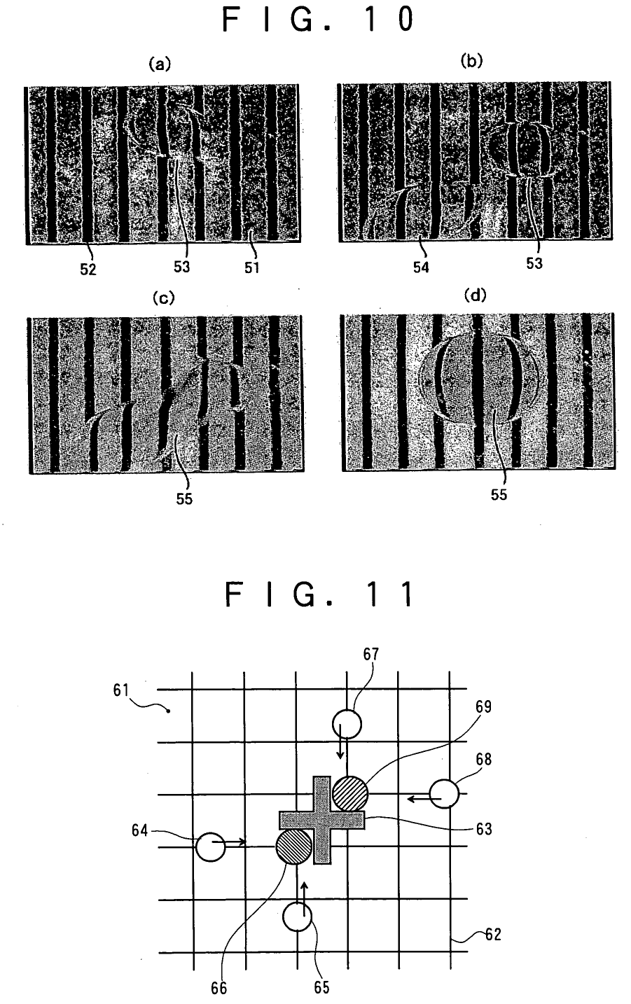

FIG. 6 is a plan view showing a device for producing microdroplets according to the present invention and FIG. 7 is an illustration showing a process for producing such microdroplets.

In these figures, reference numeral 31 represents a main body of the microdroplet-producing device, reference numeral 32 represents a microchannel in which a continuous phase 35 flows and which is disposed in the main body 31, reference numeral 33 represents a dispersion phase-feeding channel that is arranged so as to join the microchannel 32, reference numeral 34 represents a dispersion phase-feeding port, reference numeral 35 represents the continuous phase (for example, oil), reference numeral 36 represents a dispersion phase (for example, water), and reference numeral 37 represents a microdroplet.

The dispersion phase 36 is fed to the continuous phase 35 flowing in the microchannel 32 in such a manner that the flow of the dispersion phase 36 joins the flow of the continuous phase 35, as shown in FIG. 7. Part of the continuous phase 35 extends through the dispersion phase-feeding port 34, thereby forming the microdroplets 37 having a diameter smaller than the width of the dispersion phase-feeding channel 33.

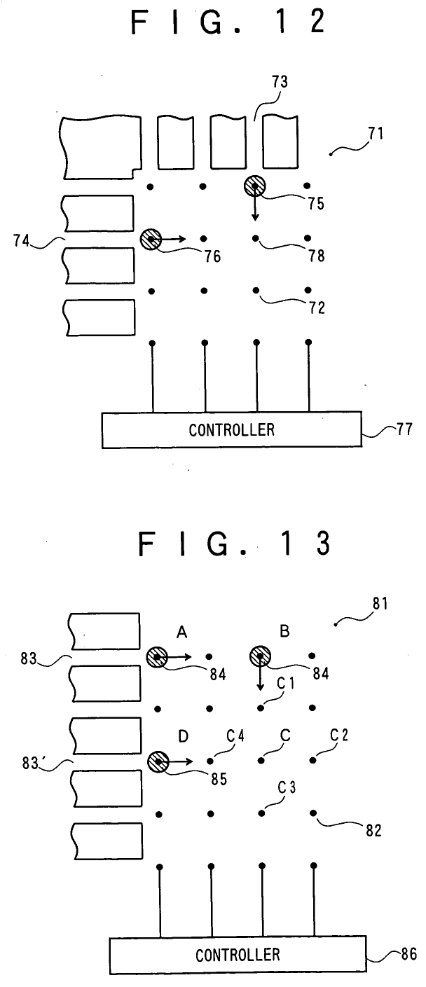

FIG. 8 is a plan view showing a device for producing microcapsules according to the present invention and FIG. 9 is an illustration showing a process for producing such microcapsules.

In these figures, reference numeral 41 represents a main body of the microcapsule-producing device, reference numeral 42 represents a microchannel in which a continuous phase 47 flows and which is disposed in the main body 41, reference numeral 43 represents a shell-forming phase-feeding channel that is arranged so as to join the microchannel 42, reference numeral 44 represents a content-forming phase-feeding channel that is arranged so as to join the microchannel 42, reference numeral 45 represents a shell-forming phase-feeding port, reference numeral 46 represents a content-forming phase-feeding port, reference numeral 47 represents the continuous phase (for example, oil), reference numeral 48 represents a shell-forming phase, reference numeral 49 represents a content-forming phase, and reference numeral 50 represents a microcapsule.

The shell-forming phase 48 and the content-forming phase 49 are fed to the continuous phase 47 flowing in the microchannel 42 in such a manner that flows of the shell-forming phase 48 and the content-forming phase 49 join the flow of the continuous phase 47, as shown in FIG. 9. The shell-forming phase 48 is fed from positions upstream to positions for feeding the content-forming phase 49 in such a manner that the shell-forming phase 48 forms a thin layer.

Microdroplets (including microcapsules) obtained according to the above procedure are manipulated by a liquid particulate-handling method of the present invention.

As described above, the present invention is applicable to liquid particulates and microspheres placed in a chemically inert solution lying on an array of electrodes.

The electrodes may be arranged in line in parallel to the X-axis or the Y-axis and may be arranged in a dotted pattern such that intersections function as the electrodes. Furthermore, wedge-shaped obstacles may be arranged on the X-Y plane. Voltages are applied to the electrodes in a traveling wave pattern such that the liquid particulates can be transported in an arbitrary manner, thereby performing separation, agitation, and mixing in an arbitrary manner. In particular, as shown in FIG. 5, a plurality of liquid particulates can be combined into one by two-dimensional control.

That is, such a device is fit for the reaction and analysis of such liquid particulates.

FIG. 10 is an illustration (photographs in place of drawings) showing a technique for combining two types of microdroplets according to the present invention.

In this example, electrode lines 52 are arranged on a substrate 51, and implementation conditions are as follows: for example, an electrode interval of 0.5 mm, an electrode width of 0.15 mm, an applied voltage of 400 V₀₋ₚ, and a frequency of 1 Hz. Voltages are applied to electrodes with the six-phase sequence [+++−−−] (a three-phase sequence is acceptable and the sequence is not limited to the above pattern). A phenolphthalein droplet 53 shown in FIG. 10(a) and a NaOH droplet 54 shown in FIG. 10(b) are manipulated so as to collide each other, as shown in FIG. 10(c). Thereby, a combined droplet 55 can be obtained, as shown in FIG. 10(d). In other words, chemical reaction, for example, alkalization of a phenolphthalein solution, can be caused.

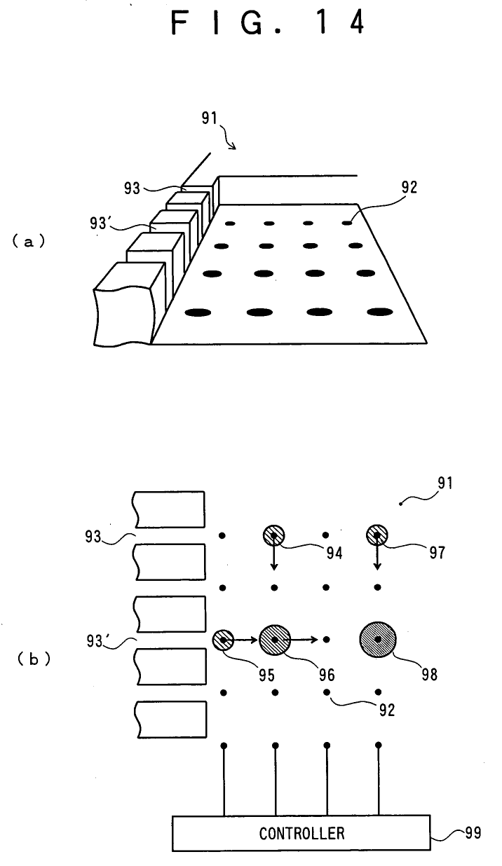

FIG. 11 is an illustration showing a technique for combining two types of microdroplets according to the present invention, wherein the microdroplets are combined at a plurality of locations.

In this figure, reference numeral 61 represents a substrate, reference numeral 62 represents X-Y parallel electrodes, reference numeral 63 represents a guide (having a cross shape herein), reference numeral 64 represents a first microdroplet, reference numeral 65 represents a second microdroplet, reference numeral 66 represents a first combined droplet, reference numeral 67 represents a third microdroplet, reference numeral 68 represents a fourth microdroplet, and reference numeral 69 represents a second combined droplet.

In this example, the guide 63 is placed on the X-Y parallel electrodes 62 disposed on the substrate 61. In the lower left region, the first microdroplet 64 and the second microdroplet 65 are transferred along the guide 63. In the upper right region, the third microdroplet 67 and the fourth second microdroplet 68 are transferred along the guide 63. These microdroplets are caused to collide so as to coalesce at desired locations, thereby forming the first combined droplet 66 and the second combined droplet 69.

FIG. 12 is an illustration (No. 1) showing a technique for combining a plurality of microdroplets using dot electrodes according to the present invention.

In this figure, reference numeral 71 represents a substrate, reference numeral 72 represents dot electrodes, reference numeral 73 represents a first microchannel, reference numeral 74 represents a second microchannel, reference numeral 75 represents a first microdroplet, reference numeral 76 represents a second microdroplet, and reference numeral 77 represents a controller.

In this example, the dot electrodes 72 (parallel electrodes may be used) are arranged on the substrate 71 in a two-dimensional manner. The microdroplets (including microcapsules and an emulsion) 75 and 76 ejected from the microchannels 73 and 74, respectively, are transferred due to a moving electric field applied to the dot electrodes 72 in the Y direction and the X direction, respectively, thereby causing them to merge at an intersection 78 to trigger off chemical change. Thus, it is expected that this technique be used in combinatorial chemistry.

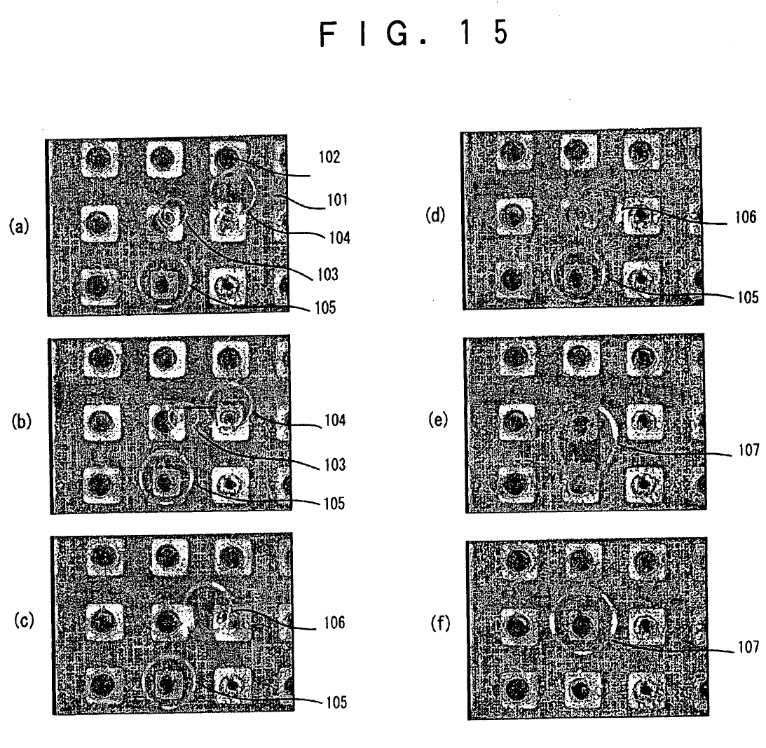

FIG. 13 is an illustration (No. 2) showing a technique for combining a plurality of microdroplets using dot electrodes according to the present invention.

In this figure, reference numeral 81 represents a substrate, reference numeral 82 represents dot electrodes, reference numerals 83 and 83′ represent microchannels, reference numeral 84 represents a first microdroplet, reference numeral 85 represents a second microdroplet, and reference numeral 86 represents a controller. In this example, the dot electrodes 82 (parallel electrodes may be used) are arranged on the substrate 81 in a two-dimensional manner, and the first microdroplet 84 and the second microdroplet 85 are ejected from the microchannels 83 and 83′, respectively. The first microdroplet 84 is transferred from point A to point B due to a moving electric field applied to the dot electrodes and then transferred toward point C. On the other hand, the second microdroplet 85 is transferred from point D to point C and then combined with the first microdroplet 84 at point C, thereby causing chemical change.

In the above procedure, the combined droplet can be rotated or deformed by applying voltages to four dot electrodes (C1, C2, C3, and C4) disposed at the upper, right, lower, and left sides, respectively, of point C, thereby causing agitation. Thus, chemical change can be promoted.

FIG. 14 is an illustration showing a technique for combining a plurality of microdroplets according to the present invention, wherein the microdroplets are combined by a multi-step process using dot electrodes. FIG. 14(a) is a perspective view showing a substrate and FIG. 14(b) is an illustration showing such a multi-step process.

In this figure, reference numeral 91 represents a substrate, reference numeral 92 represents dot electrodes, reference numerals 93 and 93′ represent microchannels, reference numeral 94 represents a first microdroplet, reference numeral 95 represents a second microdroplet, reference numeral 96 represents a first combined droplet, reference numeral 97 represents a third microdroplet, reference numeral 98 represents a second combined droplet, and reference numeral 99 represents a controller for applying voltages to the dot electrodes 92.

In this example, the dot electrodes 92 (parallel electrodes may be used) are arranged on the substrate 91 in a two-dimensional manner, and the first microdroplet 94 and the third microdroplet 97 are ejected from the microchannel 93. The second microdroplet 95 is ejected from the microchannel 93′. The first microdroplet 94 is combined with the second microdroplet 95, thereby forming the first combined droplet 96. The first combined droplet is then combined with the third microdroplet 97, thereby forming the second combined droplet 98. As described above, droplets can be combined by a multi-step process, thereby causing chemical reaction.

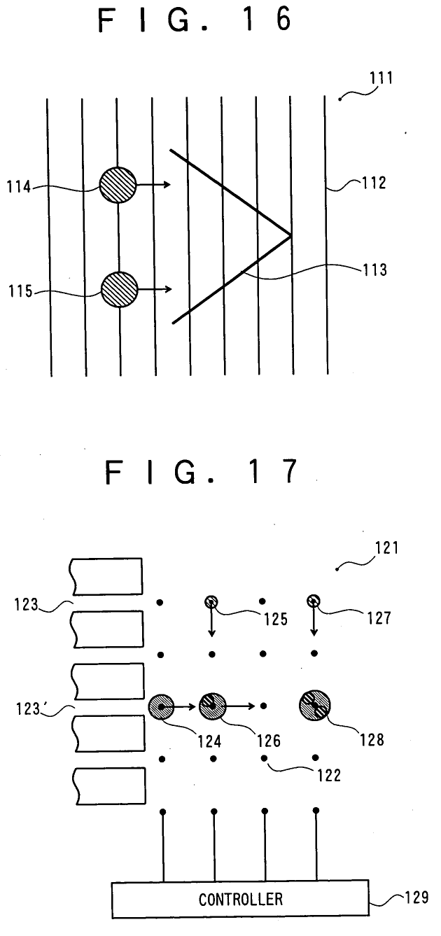

FIG. 15 is an illustration (photographs in place of drawings) showing a technique for combining a plurality of microdroplets according to the present invention, wherein the microdroplets are combined by a multi-step process using dot electrodes.

In this example, dot electrodes 102 are arranged on a substrate 101 in a two-dimensional manner, and implementation conditions are as follows: 3×3 nine-phase dot electrodes, an electrode interval of 1.0 mm, an electrode width of 0.6 mm, an applied voltage of 400 V₀₋ₚ, and a frequency of 1 Hz. Voltages are applied to the electrodes with the six-phase sequence [+++−−−].

As shown in FIG. 15(a), a first microdroplet 103, a second microdroplet 104, and a third microdroplet 105 are arranged.

As shown in FIG. 15(b), the second microdroplet 104 is moved in the direction indicated by the arrow.

As shown in FIG. 15(c), the second microdroplet 104 and the first microdroplet 103 are combined into a first combined droplet 106.

As shown in FIG. 15(d), the third microdroplet 105 is moved in the direction indicated by the arrow.

As shown in FIG. 15(e), the third microdroplet 105 and the first combined droplet 106 are combined into a second combined droplet 107.

Finally, as shown in FIG. 15(f), the second combined droplet 107 is moved to a predetermined location.

An exemplary configuration of a device for combining two microdroplets will now be described.

FIG. 16 is an illustration showing a configuration of a device, including parallel electrodes, for combining microdroplets according to the present invention.

In this figure, reference numeral 111 represents a substrate, reference numeral 112 represents parallel electrodes, and reference numeral 113 represents a guide that is a wall having a small height and a V shape, that is, a convergent shape, when viewed from above. The guide 113 can be readily provided on the substrate 111 by adhesion. Reference numeral 114 represents a first microdroplet and reference numeral 115 represents a second microdroplet.

When voltages are applied to the parallel electrodes 112, the first microdroplet 114 and the second microdroplet 115 are moved in the direction indicated by the arrow. Furthermore, the first microdroplet 114 and the second microdroplet 115 are guided with the guide (wall) 113, allowed to approach each other, and then combined. The combined droplet surmounts the guide (wall) 113 and is then moved.

The mixing of microdroplets will now be described.

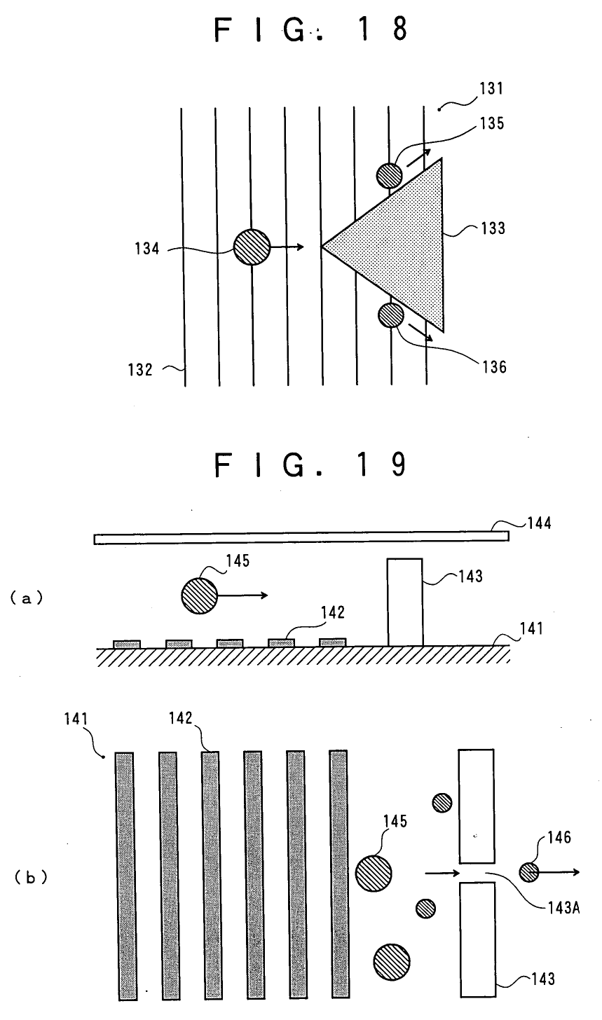

FIG. 17 is an illustration showing a technique for mixing microdroplets to form microcapsules according to the present invention.

In this figure, reference numeral 121 represents a substrate, reference numeral 122 represents dot electrodes, reference numerals 123 and 123′ represent microchannels, reference numeral 124 represents a microdroplet, reference numeral 125 represents a first ultra-microdroplet, reference numeral 126 represents a first combined droplet, reference numeral 127 represents a second ultra-microdroplet, reference numeral 128 represents a second combined droplet, and reference numeral 129 represents a controller for applying voltages to the dot electrodes 122.

In this example, the microdroplet 124 is combined with the first ultra-microdroplet 125, thereby forming the first combined droplet 126. The first combined droplet 126 is then combined with the second ultra-microdroplet 127, thereby forming the second combined droplet 128. That is, microdroplets can be combined by a multi-step process. According to the above procedure, microcapsules can be formed.

Furthermore, for example, catalyst functions may be provided to the first ultra-microdroplet 125 and the second ultra-microdroplet 127 such that the first and second ultra-microdroplets 125 and 127 act on the microdroplet 124.

The division of microdroplets will now be described.

FIG. 18 is an illustration showing a configuration of a device for dividing microdroplets according to an example of the present invention.

In this figure, reference numeral 131 represents a substrate, reference numeral 132 represents parallel electrodes, reference numeral 133 represents a dividing means (wall) having tips and a triangular shape when viewed from above, reference numeral 134 represents a microdroplet, and reference numerals 135 and 136 represent sub-microdroplets formed by the division with the dividing means (wall) 133.

In this example, when voltages are applied to the parallel electrodes 132, the microdroplet 134 is moved in the direction indicated by the arrow to collide against the dividing means (wall) 133 and then divided, thereby forming a plurality of the sub-microdroplets 135 and 136.

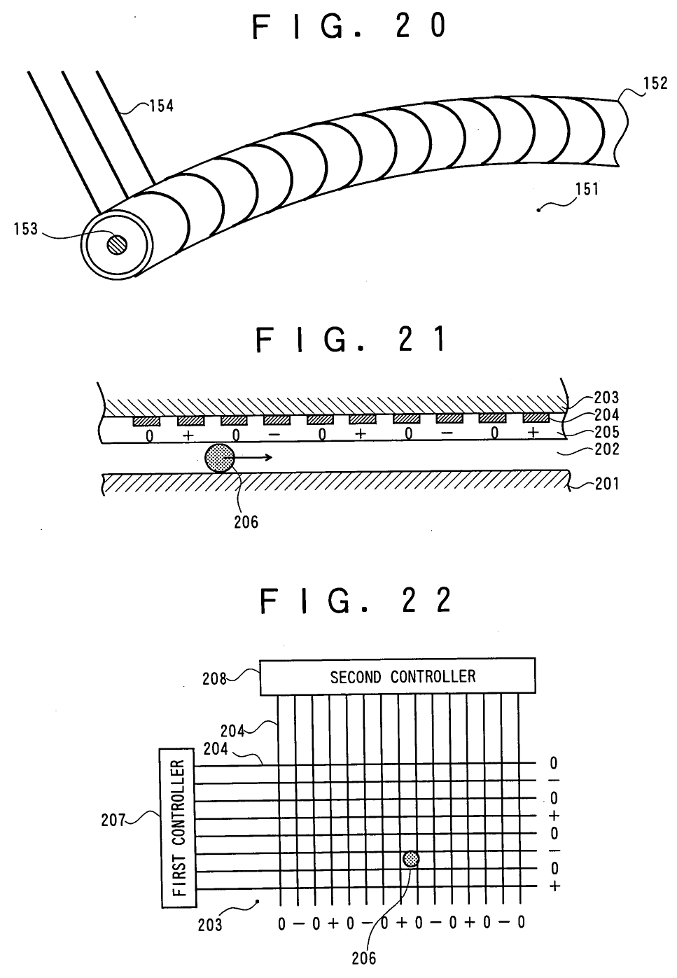

FIG. 19 is an illustration showing a configuration of a device for separating (filtrating) microdroplets according to an example of the present invention. FIG. 19(a) is a side elevational view thereof and FIG. 19(b) is a plan view thereof.

In these figures, reference numeral 141 represents a substrate, reference numeral 142 represents parallel electrodes disposed on the substrate 141, reference numeral 143 represents a filter (wall) having a microchannel 143A, reference numeral 144 represents a cover, reference numeral 145 represents a microdroplet, and reference numeral 146 represents a sub-microdroplet passing through the microchannel 143A.

In this example, among microdroplets remaining at an area upstream to the filter (wall) 143, the sub-microdroplets 146 having a size enough to pass through the microchannel 143A are separated (filtrated) and then allowed to flow downstream. It is not necessary that the filter (wall) 143 is in contact with the cover 144, and a space may be disposed therebetween.

Such microdroplets can be separated depending on the density. For example, channels may be arranged at different regions of the filter (wall) 143 such that microdroplets having higher density pass through channels disposed at a lower region of the filter (wall) 143 and microdroplets having lower density pass through channels disposed at an upper region.

FIG. 20 is an illustration showing a configuration of a microdroplet-handling device according to an example of the present invention, wherein the device includes an electrostatic transport tube for transporting microdroplets.

In this figure, reference numeral 151 represents a substrate, reference numeral 152 represents the electrostatic transport tube disposed on the substrate, reference numeral 153 represents a microdroplet transported in the electrostatic transport tube 152, and reference numeral 154 represents a three-phase electrode (a six-phase type may be used) for applying voltages.

In this example, the electrostatic transport tube 152 is placed on the substrate 151 such that the microdroplets 153 can be transported. Thus, a special channel can be formed, the microdroplet 153 can be fed from a predetermined position, and the microdroplet 153 can be ejected from a predetermined position.

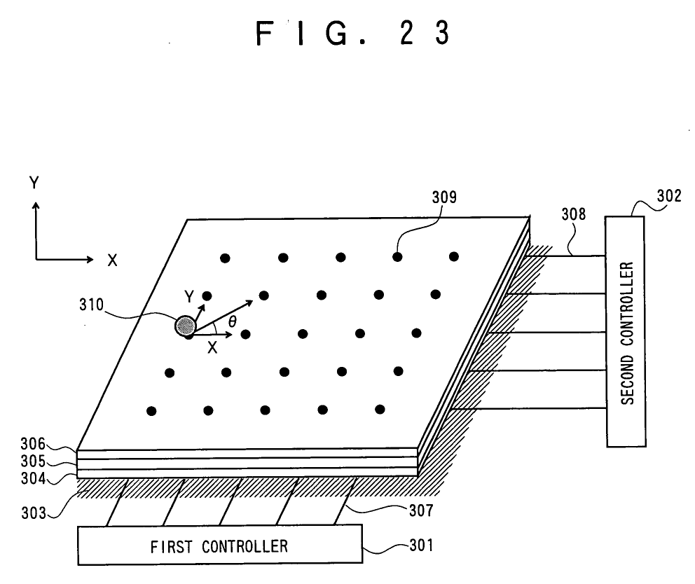

FIG. 21 is a schematic sectional view showing a microdroplet-handling device according to an example of the present invention, wherein the device has a substrate, disposed above a solution, having handling electrodes.

In this figure, reference numeral 201 represents a lower insulating plate, reference numeral 202 represents a chemically inert solution (for example, oil), reference numeral 203 represents a substrate disposed above the chemically inert solution 202, reference numeral 204 represents electrode lines disposed under the substrate 203, reference numeral 205 represents a hydrophobic insulating film for covering the electrode lines 204, and reference numeral 206 represents a microdroplet (for example, water).

In the handling device shown in FIG. 1, the substrate having the electrode lines thereon is disposed below the solution. In contrast, in this example, the substrate 203 having the electrode lines thereunder is disposed above the chemically inert solution 202. In this case, the chemically inert solution 202 preferably has a density larger than that of the microdroplets 206, which are therefore floatable. When the chemically inert solution 202 has substantially the same a density as that of the microdroplets 206 or the microdroplets 202 have a density larger than that of the chemically inert solution 202, channels in which the chemically inert solution 202 flows preferably have substantially the same diameter as that of the microdroplets 206.

According to the above configuration, the substrate 203 having the electrode lines 204 can be readily set at an upper region in a cell filled with the solution 202 having the microdroplets 206 therein and the substrate can be readily replaced.

FIG. 22 is an illustration showing a method for handling liquid particulates using a handling device according to an example of the present invention, wherein the device has a substrate, disposed above solution, having handling electrodes.

As shown in FIG. 22, each microdroplet 206 is placed below the substrate 203 having the electrode lines 204 arranged in a two-dimensional manner and voltages applied to the electrode lines 204 are controlled with a first controller 207 and/or a second controller 208, thereby manipulating the microdroplet 206 in an arbitrary two-dimensional direction.

FIG. 23 is an illustration showing a substrate having handling electrodes and also showing a method for applying voltages according to an example of the present invention.

In this figure, reference numeral 301 represents a first controller; reference numeral 302 represents a second controller; reference numeral 303 represents a base; reference numeral 304 represents a first wiring substrate; reference numeral 305 represents a second wiring substrate; reference numeral 306 represents a third wiring substrate; reference numeral 307 represents wiring lines, connected to the first controller 301, for applying voltages; reference numeral 308 represents wiring lines, connected to the second controller 302, for applying voltages; reference numeral 309 represents dot electrodes disposed on the third wiring substrate 306; and reference numeral 310 represents a liquid particulate. The dot electrodes 309 may be arranged in various two-dimensional patterns in such a manner that various wiring patterns (not shown) are formed on the multilayer structure consisting of the wiring substrates 304, 305, and 306, which are connected to each other via through-holes (not shown). In the above example, the three wiring substrates are used. However, larger number of wiring substrates may be used.

Thus, when voltages are applied to the dot electrodes arranged in various patterns with first controller 301 or the second controller 302, the liquid particulate 310 can be manipulated in the X direction and/or the Y direction or in the direction forming an angle of θ degree with respect to the X direction. Furthermore, the liquid particulate 310 can be manipulated in various modes, for example, the liquid particulate 310 can be moved at various velocities, by controlling the intensity and applying time of voltages applied from the controllers 301 and/or 302. The liquid particulate can be manipulated depending on the size by varying the pattern of applied voltages.

The present invention is not limited to the above examples and various modifications may be performed within the scope of the present invention. It is construed that the present invention covers such modifications.

As described above, according to the present invention, the following advantages can be obtained.

(A) Droplets can be prevented from being vaporized and thereby the handling of droplets can be appropriately performed. Thus, a device of the present invention is fit for the reaction or analysis of liquid particulates.

(B) Electrode lines form handling electrodes and thus such electrodes can be readily manufactured by a micro-wiring technique.

(C) When the handling electrodes are of a dot type and desired voltages are applied thereto in a dotted pattern, the handling of droplets can be appropriately performed with high resolution.

(D) A plurality of liquid particulates can be set so as to collide, thereby combining them.

(E) A plurality of liquid particulates can be set such that the liquid particulates are combined or mixed at a plurality of locations on a single substrate.

(F) A plurality of liquid particulates can be set such that the liquid particulates are combined by a multi-step process.

(G) A plurality of liquid particulates can be set such that the liquid particulates are combined by a multi-step process.

(H) Microdroplets can be each divided into a plurality of sub-microdroplets.

(I) A plurality of liquid particulates can be set such that the resulting liquid particulates are separated (filtrated).

### INDUSTRIAL APPLICABILITY

According to a method and device for handling liquid particulates according to the present invention, droplets can be prevented from being evaporated and thereby the handling of such droplets can be appropriately performed. Thus, such a device is fit for the reaction or analysis of liquid particulates in the field of the drug production and biotechnology.

1. (Amended) A method for handling liquid particulates, comprising the steps of:
(a) setting a chemically inert solution, having microdroplets therein, on a substrate having handling electrodes arranged in a two-dimensional manner;
(b) controlling the voltages of the handling electrodes; and
(c) handling the microdroplets in the chemically inert solution.

2. The method for handling liquid particulates according to claim 1 further comprising a step of combining the microdroplets to cause chemical reaction.

3. (Amended) A device for handling liquid particulates, comprising:
(a) a substrate having handling electrodes arranged in a two-dimensional manner;
(b) a chemically inert solution set for the substrate;
(c) microdroplets placed in the chemically inert solution; and
(d) a controller for controlling the voltages of the handling electrodes to handle the microdroplets in the chemically inert solution.

4. (Amended) A device for handling liquid particulates, comprising:
(a) a substrate having handling electrodes arranged in a two-dimensional manner;
(b) a chemically inert solution set for the substrate;
(c) microdroplets placed in the chemically inert solution; and
(d) a controller for controlling the voltages of the handling electrodes to handle the microdroplets in the chemically inert solution,
(e) wherein a plurality of the microdroplets are handled, whereby new microdroplets are combined.

5. (Amended). A method for handling liquid particulates, comprising the steps of:
(a) setting a chemically inert solution, having a plurality of microdroplets therein, on a substrate having handling electrodes arranged in a two-dimensional manner;
(b) controlling the voltages of the handling electrodes; and
(c) handling a plurality of the microdroplets in the chemically inert solution to allow a plurality of the microdroplets to interact to combine new microdroplets.

6. The method for handling liquid particulates according to claim 5, wherein the combining is performed by a multi-step process.

7. (Amended) A method for handling liquid particulates, comprising the steps of:
(a) setting a chemically inert solution, having a plurality of microdroplets therein, on a substrate having handling electrodes arranged in a two-dimensional manner;
(b) controlling the voltages of the handling electrodes; and
(c) handling a plurality of the microdroplets in the chemically inert solution to combine a plurality of the microdroplets to form microcapsules.

8. (Amended) A method for handling liquid particulates, comprising the steps of:
(a) setting a chemically inert solution, having microdroplets therein, on a substrate having handling electrodes arranged in a two-dimensional manner;
(b) controlling the voltages of the handling electrodes; and
(c) handling the microdroplets in the chemically inert solution to separate the microdroplets.

9. (Amended) A method for handling liquid particulates, comprising the steps of:
(a) setting a chemically inert solution, having a plurality of microdroplets therein, on a substrate having handling electrodes arranged in a two-dimensional manner;
(b) controlling the voltages of the handling electrodes; and
(c) handling a plurality of the microdroplets in the chemically inert solution to separate small microdroplets having a size smaller than or equal to a predetermined value from the microdroplets having different sizes by filtration.

10. (Deleted)

11. (Amended) A device for handling liquid particulates, comprising:
(a) a substrate having handling electrodes arranged in a two-dimensional manner;
(b) a chemically inert solution, set for the substrate, having a plurality of microdroplets therein;
(c) a controller for controlling the voltages of the handling electrodes; and
(d) a means for handling a plurality of the microdroplets in the chemically inert solution to combine a plurality of the microdroplets each other.

12. The device for handling liquid particulates according to claim 4 or 11, wherein the substrate has a guide, whereby the droplets are combined.

13. The device for handling liquid particulates according to claim 4 or 11, wherein the substrate has a guide, whereby the droplets are combined at a plurality of regions.

14. The device for handling liquid particulates according to claim 4 or 11, wherein the microdroplets are moved on the substrate such that the microdroplets are combined or mixed.

15. The device for handling liquid particulates according to claim 4 or 11 further comprising a dividing means for dividing each microdroplet, moved on the substrate, into a plurality of sub-microdroplets.

16. The device for handling liquid particulates according to claim 4 or 11 further comprising a filter for separating small microdroplets having a size smaller than or equal to a predetermined value from a plurality of the microdroplets having different sizes.

17. (Deleted)

18. The device for handling liquid particulates according to claim 3, 4, or 11, wherein the substrate is placed below the solution.

19. The device for handling liquid particulates according to claim 3 or 4, wherein the substrate is placed above the solution.
